(19) United States
(12) Patent Application Publication
(10) Pub. No.: US 2018/0108979 A1
(43) Pub. Date: Apr. 19, 2018

(54) Radio Frequency QUAD Hat System

(71) Applicant: Felipe Nazario-Romero, Fairborn, OH (US)

(72) Inventor: Felipe Nazario-Romero, Fairborn, OH (US)

(73) Assignee: United States of America as represented by the Secretary of the Navy, Patuxent River, MD (US)

(21) Appl. No.: 15/296,316

(22) Filed: Oct. 18, 2016

(51) Int. Cl. H01Q 1/30; H01Q 9/06

(52) U.S. Cl. CPC H01Q 1/30; H01Q 9/065

(57) ABSTRACT

A radio frequency quad hat system for decreasing transmission power when conducting tests on aircraft when the aircraft is on ground, the aircraft having two wings and two stabilizers, each wing having a leading edge transmitting conformal IFF antenna and each stabilizer having a trailing edge transmitting conformal IFF antenna. The system includes two forward hats, each forward hat corresponding to a leading edge transmitting conformal IFF antenna, the forward hats comprising of frequency selective material and three dipoles; and, two aft hats, each aft hat corresponding to a trailing edge transmitting conformal IFF antenna, the aft hats comprising of frequency selective material and three dipoles, the two forward hats and the aft hats able to transmit and receive communications at a decreased transmission level during testing.

### CROSS REFERENCES

The present application is related to application Ser. No. 14/644,696, filed Mar. 11, 2015, entitled “Radio Frequency Hat System.” Both applications have the same inventor and assignee. application Ser. No. 14/644,696 is incorporated herein by reference, and is not admitted to be prior art with respect to the present invention.

### STATEMENT OF GOVERNMENT INTEREST

The invention described herein may be manufactured and used by or for the Government of the United States of America for governmental purposes without payment of any royalties thereon or therefor.

### BACKGROUND

Test personnel often must gather data from emissions of aircraft, particularly military aircraft. This data is necessary for certifying equipment. The Identification System or Identification Friend or Foe (IFF) system provides information to the Air Traffic Controller (ATC) that includes basic information on the aircraft (altitude, “who am I”/flight number, and other information). The F-35 Lightning II aircraft has the capability of functioning as an airborne interrogating platform, with the capability of sending interrogation requests to other flying aircraft. Currently, methods exist to gather the required emissions/data that minimize the impact of unwanted emissions into the National Airspace, and minimize the negative effects of these emissions on the health and safety of the testing personnel. However, testing personnel cannot effectively use these methods on the F-35 Lightning II, due to the unique characteristics of the aircraft. Existing tests for the conformal identification System require close contact between the conformal antennas and the measuring equipment to ensure there is no interference from other sources. However, the preferred method into directly connect the measuring equipment to the antenna. This preferred test would require connection within the airframe, which would require panels to be removed in order to access antenna terminals within the wing. Many other platforms have the capability of this approach. Due to the unique design of the F-35 Lightning II, this method is a high cost, time-intensive, and complex task. The emissions carrying the information of the aircraft are radiated over the international frequency of 1030 and 1090 MHz, and goes to all receivers dedicated to ATC functions. During flight, the aircraft can generate and receive multiple requests for identification. For this purpose, the IFF system uses the antennas located at the wings and stabilizer sections of the aircraft to transmit this information.

The currently used method for testing the emissions requires personnel to walk up to the aircraft, and physically place an ante as close as possible to the aircraft wings and elevators in order to record the emissions through test equipment. These measurements are not a complete representation of the actual transmission coming from the aircraft, due to noise and interference from outside and other sources. In addition, it is a violation of the Federal Aviation Administration (FAA) regulations for unwanted transmissions corning from ground tests to be in the IFF band. The FAA is the leading and sole source authority in approving any IFF system on any United States platform, civilian or military. Additionally, personnel must stay close to the aircraft while holding an antenna for the top part of the aircraft. This creates a safety and health hazard. Therefore, there is a need for a radio frequency cover system for attenuating transmission power when conducting tests on the ground.

The military aircraft radio frequency quad hats are a series of edge wing and stabilizer foam-based covers used to receive, and transmit emissions from the aircraft's identification antennas. The hats cover the antennas and allow measuring data and signals while attenuating the level of transmission, in addition to directional measurement of emissions. Conformal antennas are typically designed into the aircraft's fuselage, matching the shape of the aircraft in order to maintain aerodynamic characteristics.

### SUMMARY

The present invention is directed to a radio frequency cover system for attenuating or decreasing transmission ponder when conducting tests on aircraft on the ground with the needs enumerated above and below.

The present invention is directed to a radio frequency cover system for attenuating or decreasing transmission power when conducting tests on aircraft on the ground, which includes two forward hats and two aft hats. Each forward hat corresponds to a forward edge transmitting conformal IFF antenna, and each aft hats corresponds to an elevator trailing transmitting conformal IFF antenna or trailing edge transmitting conformal IFF antenna. The forward hats and the aft hats include frequency selective material (FSM). FSM can be defined as, but without limitation as, material that can isolate specific frequencies by blocking some frequencies, while allowing others to go through it. All the hats have three dipoles, to allow directional measurement and transmission during testing. All the hat dipoles are able to transmit and receive communications with the IFF system while having a decreased transmission level during testing.

It is a feature of the present invention to provide a system that is inexpensive, easy and safe to use.

It is a feature of the present invention to provide a system that does not violate of any FAA rules.

It is a feature of the present invention to provide a system that can be used for a series of tests requiring measurements of transmissions from conformal antennas, while attenuating the signal to comply with federal guidelines concerning transmissions into national airspace.

### DRAWINGS

These and other features, aspects and advantages of the present invention will become better understood with reference to the following description and appended claims, and accompanying drawings wherein:

FIG. 1A is a top view of an aircraft with the quad hat system in operation;

FIG. 1B is a bottom view of an aircraft with the quad hat system in operation;

FIG. 2 is a side and top view of the forward hat;

FIG. 3 is a front view of the forward hat;

FIG. 4 is a rear perspective side view and a cross sectional view of the forward hat;

FIG. 5 is a side and top view of the aft hat;

FIG. 6 is a rear view of the aft hat; and,

FIG. 7 is front perspective view and a cross sectional view of the aft hat.

### DESCRIPTION

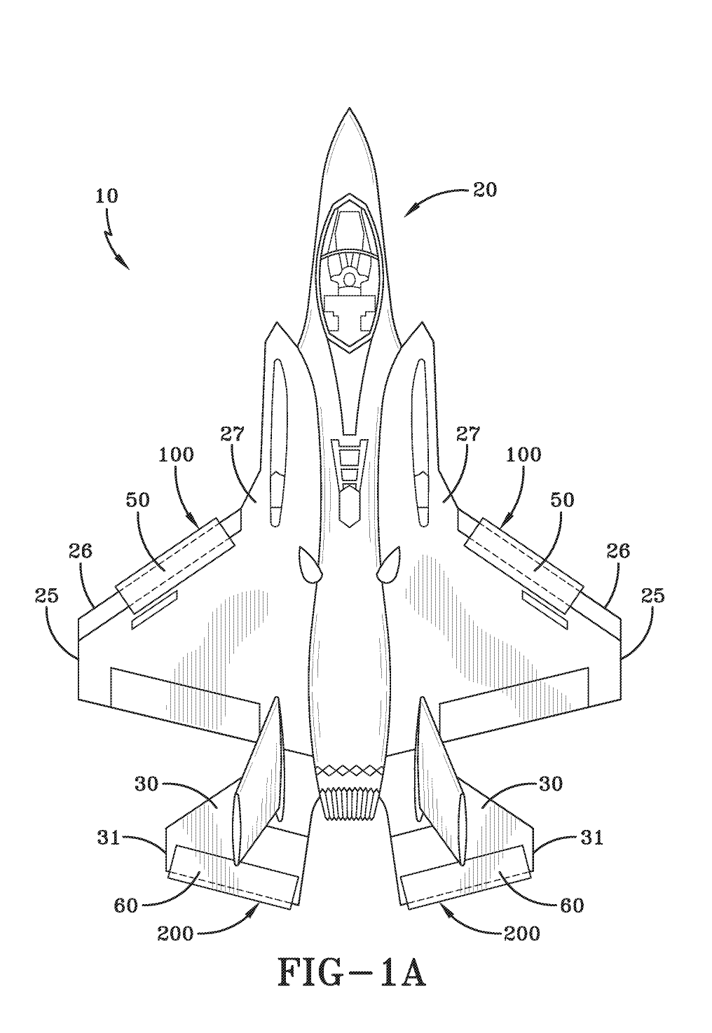

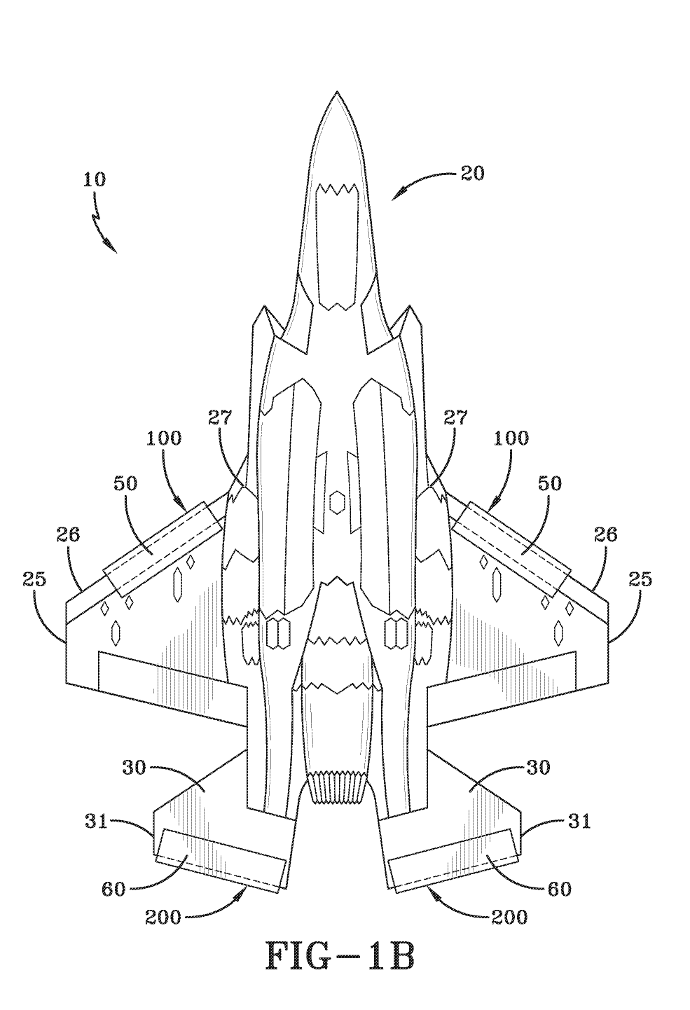

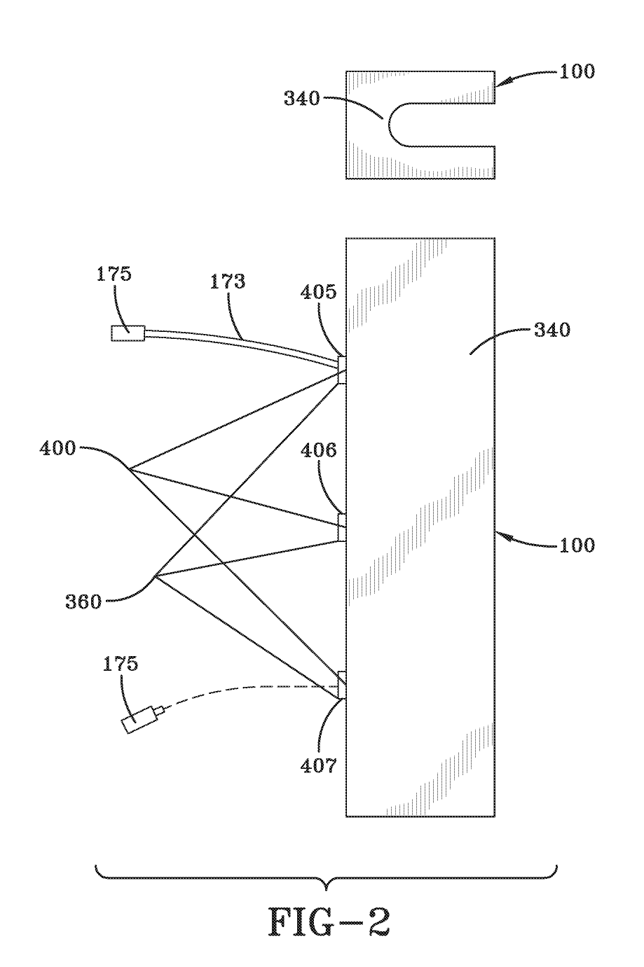

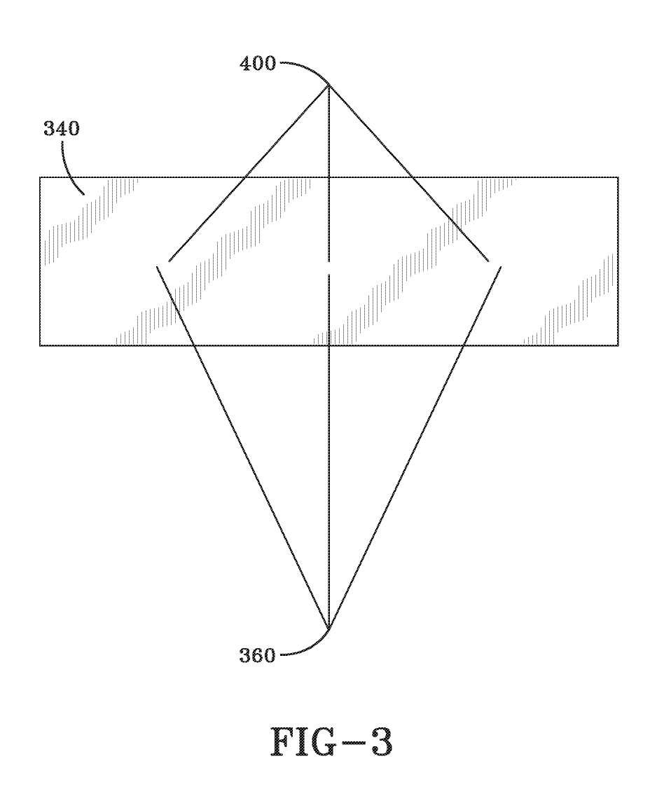

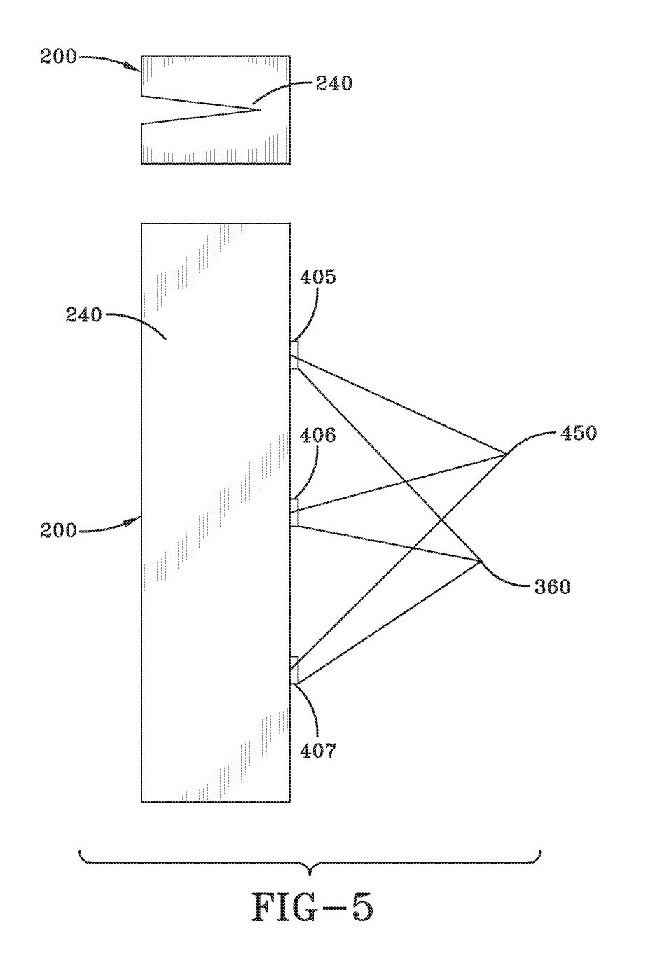

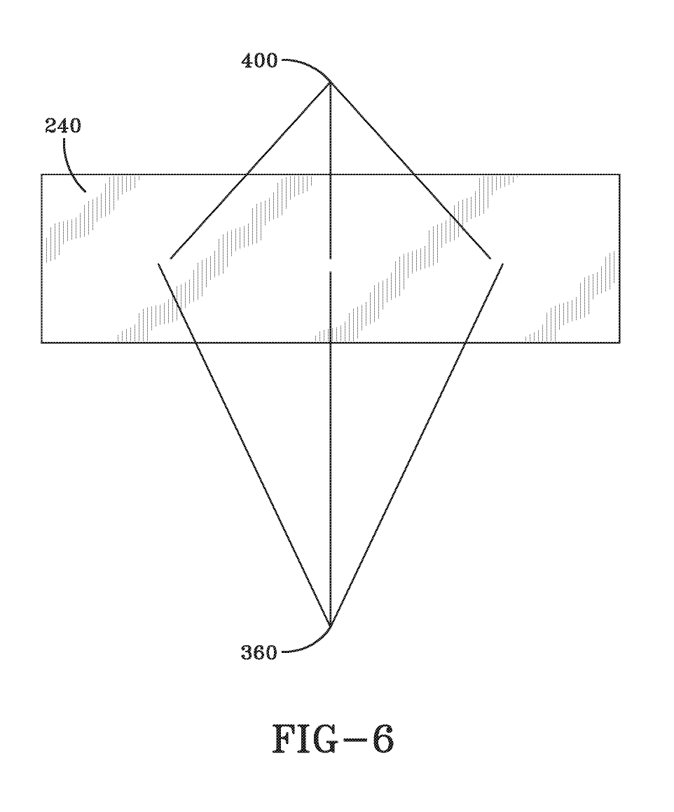

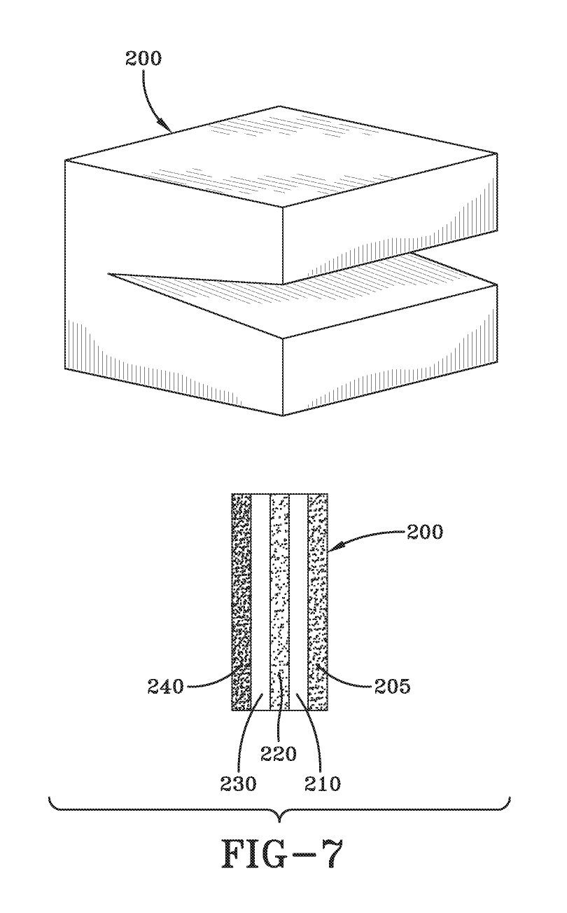

The preferred embodiments of the present invention are illustrated by way of example below and in FIGS. 1-7. The radio frequency quad hat system 10 is utilized on an aircraft 20 with two wings 25 and two stabilizers 30, and each wing 25 has forward wing leading edge transmitting conformal IFF antenna 50 and each stabilizer 30 has a trailing elevator wing edge transmitting conformal IFF antenna 60. As shown in FIGS. 1A and 1B, the radio frequency quad hat system 10 for decreasing transmission power when conducting tests on the ground, includes two forward hats 100 corresponding to a forward wing leading edge transmitting conformal IFF antenna 50 (each forward hat 100 covers a corresponding forward wing leading edge transmitting conformal IFF antenna 50 in FIG. 1A and 1B), and two aft hats 200 corresponding to a trailing elevator wing edge transmitting conformal IFF antenna 60 (each aft hat 200 covers a corresponding trailing elevator wing edge transmitting conformal IFF antenna 60 in FIG. 1A and 1B). Each forward hat 100 and each aft hat 200 contains frequency selective material. As shown in FIG. 2, each forward hat 100 has three equidistant forward hat dipoles 400, and as shown in FIG. 5, each aft hat 200 has three equidistant aft hat dipoles 450. The forward hat dipoles 400 and the aft hat dipoles 450 are able to transmit and receive communications, while having decreased transmission level during testing to the outside environment.

In the description of the present invention, the invention will be discussed in a military aircraft environment. However, this invention can be utilized for any type of application that requires use of a radio frequency hat system that decreases the power of transmissions.

In operation, each forward hat 100 covers the wing forward leading edge transmitting conformal IFF antenna 50, while each aft hat 200 covers the wing aft trailing edge transmitting conformal IFF antenna 60, If an aircraft 20 only has one transmitting IFF antenna, then the system 10 only utilizes one hat appropriate to the location of the antenna. As shown in FIG. 1, in an aircraft 20, each wing forward leading edge transmitting conformal IFF antenna 50 may be located on the leading edge 26 of each wing 25 of the aircraft 20 beneath the skin 27 of the aircraft 20. Each wing aft trailing edge transmitting conformal IFF antenna 60 may be located on the trailing edge 31 of each stabilizer 30 of the aircraft 20 beneath the skin 27. Each wing 25 has a wing leading edge perimeter and each stabilizer 30 has a trailing edge perimeter. Each forward hat 100 can extend around the wing leading edge perimeter, while ach aft hat 200 can extend around the trailing edge perimeter.

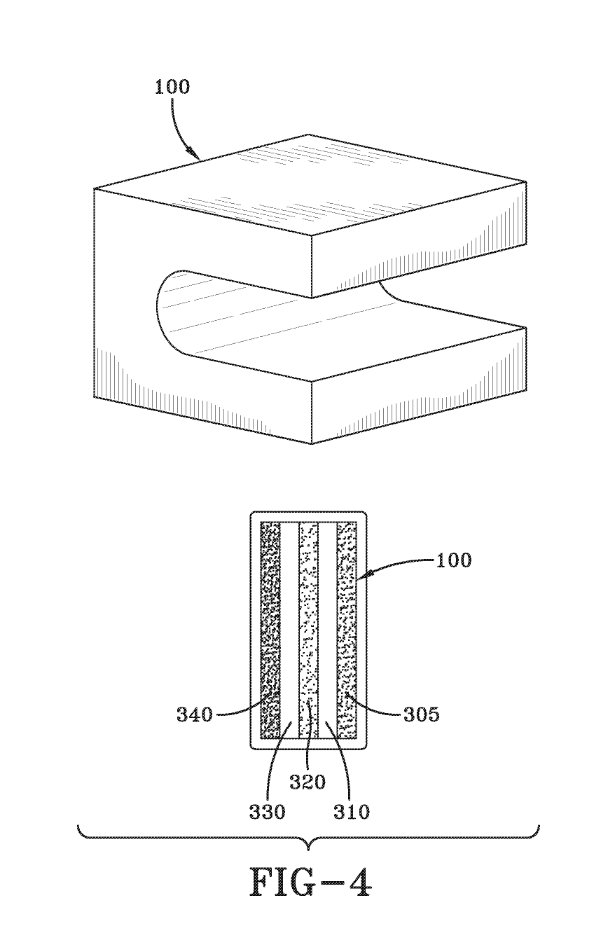

As shown in FIGS. 2 and 4, each forward hat 100 may include a combination of a frequency selective material (FSM) layer 305, a first polymer adhesive layer 310, an aluminum foil layer 320, a second polymer adhesive 330, rigid foam 340, three forward dipoles 400, and hardware 360 to connect the test equipment, or particularly an RF connector 175, to the forward hat 100. In the preferred embodiment, as shown in FIG. 4, the closest layer to the skin 27 of the aircraft 20 will be a FSM layer 305, followed up by the first polymer adhesive layer 310, followed by the aluminum foil layer 320 (or any type of reflective layer), the second polymer adhesive layer 330, followed by rigid pre-fabricated foam 340 of any type that provides rigidity. The last layer closest to the aircraft 20, is a FSM layer 305 to provide good performance and protect the skin/fuselage of the aircraft 20. The layers may be attached to each other via a polymer adhesive, but any connection method or adhesive that is practicable may be utilized.

In the preferred embodiment, as shown in FIGS. 5-7, the aft hat 200 includes a FSM layer 205, followed by a first polymer adhesive layer 210, followed by the aluminum foil layer 220 (or any type of reflective layer), a second polymer adhesive layer 230, followed by the rigid pre-fabricated foam 240 of any type that provides rigidity. The last layer closer to the aircraft is made of the FSM to provide good performance and protect the skin/fuselage of the aircraft. The layers may be attached to each other via the polymer adhesive, but any connection method or adhesive that is practicable may be utilized. The RF connectors 175 and any other RE connectors utilized in the invention allow communication and connection to any type of equipment specifically, but without limitation, equipment for analyzing equipment, such as, but not limited to, an IFF test set, an oscilloscope, a computer, a Spectrum Analyzer, an RF Power Meter, and other common RF measuring devices used in test applications.

The FSM may be a semi-rubber synthetic material tuned specifically for the frequency required for the transmission in the IFF band. The aluminum foil layers 220, 320 work as a reflector to ensure no emissions go beyond the FSM layer 305. The polymer adhesive is simple RTV used to fasten the different materials. The pre-fabricated rigid foam 240, 340 provides enough pressure and protection between the wing and the box. This pressure is necessary to maintain the box in place.

Each forward hat dipole 400 and aft hat dipole 450 will receive from, and transmit to, the conformal antennas 50, 60. In the preferred embodiment, the forward hat dipoles 400 and the aft hat dipoles 450 are frequency timed copper strips. As shown in FIGS. 2 and 5, each forward hat 100 and aft hat 200 includes three (3) dipoles 400—a first dipole 405, a second dipole 406, and a third dipole 407. The first dipole 405 is connected to an RE connector 175 via a cable 173, which may be an RF cable. The second dipole 406 and the third dipole 407 can be connected simultaneously or in succession, to measure angled emissions conning, going into the aircraft antenna. Each aft hat 200 encases the trailing edge 31 of the stabilizer 30 in the similar fashion as the forward hat 100 encases the leading edge 26 of the wing 25.

The rigid pre-fabricated foam 240 of each aft hat 200 may differ from each forward hat 10. In the preferred embodiment, the rigid pre-fabricated foam 240 of each aft hat 200 has a triangular shape cut, while the rigid pre-fabricated foam 340 of each forward hat 300 is circular/oval in shape.

In the description of the present invention, the invention will be discussed in an aircraft and ship environment; however, this invention can be utilized for any type of application that requires use of a battery.

When introducing elements of the present invention or the preferred embodiment(s) thereof, the articles “a,” “an,” “the,” and “said” are intended to mean there are one or more of the elements. The terms “comprising,” “including,” and “having” are ended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A radio frequency quad hat system for decreasing transmission power when conducting tests on aircraft when the aircraft is on ground, the aircraft having two wings and two stabilizers, each wing having a leading edge transmitting conformal IFF antenna and each stabilizer having a trailing edge transmitting conformal IFF antenna, the system comprising:
two forward hats, each forward hat corresponding to a leading edge transmitting conformal IFF antenna, the forward hats comprising of frequency selective material and three dipoles; and,
two aft hats, each aft hat corresponding to a trailing edge transmitting conformal IFF antenna, the aft hats comprising of frequency selective material and three dipoles, the two forward hats and the aft hats able to transmit and receive communications at a decreased transmission level during testing.

2. The radio frequency quad hat system of claim , wherein the forward hat is comprised of a first selective material layer, a reflective layer, a rigid layer, and a second frequency selective material layer, if necessary.

3. The radio frequency quad hat system of claim 2, wherein each wing has a wing leading edge perimeter, each forward hat extending around the wing leading edge perimeter.

4. The radio frequency quad hat system of claim 3, wherein the aft hat is comprised of a first frequency selective material layer, a reflective layer, a rigid layer, and a second frequency selective material layer.

5. The radio frequency hat system of claim 4, wherein the aft hat includes a frequency selective material that extends around the wing trailing edge conformal IFF antenna perimeter.

6. The radio frequency quad hat system of claim 5, wherein the dip e are frequency tuned copper strips.
